(19) United States
(12) Patent Application Publication
(10) Pub. No.: US 2005/0076563 A1
(43) Pub. Date: Apr. 14, 2005

(54) Multiple level farming module and system

(76) Inventor: Sadeg M. Faris, Pleasantville, NY (US)

Correspondence Address: REVEO, INC., 3 WESTCHESTER PLAZA, ELMSFORD, NY, 10523, US

(21) Appl. No.: 10/962,993

(22) Filed: Oct. 12, 2004

Related U.S. Application Data
(60) Provisional application No. 60/510,592, filed on Oct. 10, 2003.

(51) Int. Cl. A01G 7/00; A01G 31/00

(52) U.S. Cl. 47/58.1 LS; 47/60

(57) ABSTRACT

The present invention circumvents inherent inefficiencies of photosynthesis by exposing chloroplast (or equivalents thereof) to light in a periodic manner during the organisms' “daylight” cycle. Optical, electro-optical, and/or electromechanical techniques are introduced to conventional farming methods to increase the conversion efficiency and farming yield many-fold. A module is provided that carries out the above benefits. The module includes: a solar distribution sub-system; and a structure having a plurality of growing levels configured and dimensioned to support a desired quantity of plant life and associated nutrient sources (e.g., soil, hydroponic, or an equivalent nutrient source).

### CROSS-REFERENCE TO RELATED APPLICATIONS

This application claims the benefit under 35 U.S.C. §119(e) of U.S. Provisional Patent Application Ser. No. 60/510,592 filed on Oct. 10, 2003, entitled “Multiple Level Farming Module And System,” which is incorporated by reference herein

### TECHNICAL FIELD

The present invention relates generally to farming systems and methods.

### BACKGROUND OF THE INVENTION

Macroscopically, present farming techniques rely on an inherent inefficiencies of land usage. Land is required for planting of the crops to be farmed. Land is also used, either locally or at some distance from the crops, for water storage, e.g., in the form of ponds. Further, land is also used, either locally or at some distance from the crops, for energy storage, distribution, petroleum fuel storage/production, etc.

However, usage of ponds for water collection leads to inherent inefficiencies. For example, unwanted minerals and other impurities collected in the pond (e.g., within the soil, algae, other organisms) are transported along with the water for the plants. Such impurities may attract pests, which in turn must be countered with pesticides. While these impurities may be prevented to some extent with water treatment, there is a clear expense associated therewith.

Further, the problems associated with widespread reliance of energy from power plants and petroleum fuel are well documented, from socioeconomic, environmental, economical and political standpoints.

Hessel et al. U.S. Pat. No. 6,508,033 discloses an automated system for yielding agricultural produce. In general, the system of Hessel et al. includes a three-dimensional growing region and robotic support systems including seeders, irrigation, filtration, and harvesting. Also taught by Hessel et al. is a system for increasing plant efficiency by introducing oxygen in the irrigation streams. However, as taught therein, lighting is provided in typical daytime-nighttime cycles.

In general, the well known photosynthesis process¹ converts solar energy into chemical energy by formation of carbohydrate, proteins and other products used as food for the plants. Photosynthesis is the largest scale biosynthetic process on Earth. Typically, light is harvested during the light reactions, and the energy created during the light harvesting is utilized in the dark reactions. It is well known, however, that the photonic energy conversion efficiency is about 1% or less, likely on the order of a fraction of a percent. In spite of this, conventional prior art farming methods are reasonably well developed, producing reasonably affordable food.
¹ For a concise summary of the photosynthesis reactions, see, e.g., botany course notes from University of Arkansas at Little Rock, http://www.ualr.edu/˜botany/lightrxns.html and http://www.ualr.edu/˜botany/darkrxns.html, both of which are incorporated herein by reference.

For substances other than food, however, farming products are not cost effective. For instance, substances such as biomass, biodegradable plastics, pharmaceuticals, and other materials with special desirable properties derived from proteins and other plant products are not cost effective. Further, other specialty applications, such as algae production and biofuel production have limited economic effectiveness utilizing existing techniques.

Further, in general, only two relatively narrow portions of the light spectrum (e.g., centered at about 680 nm and at about 700 nm, although other bandwidths are useful for certain types of plant life) are particularly useful to the plant growth.

Present farming techniques rely on overexposure of light, both in terms of time and spectral components.

Further, most present farming techniques are in uncontrolled environments, resulting in fears associated with bioengineered plants spreading and overtaking other plant life.

Thus, it would be desirable to provide a method of and system for farming that overcomes these light inefficiencies.

### OBJECTS OF THE INVENTION

One object of the present invention is to circumvent the inherent inefficiencies of photosynthesis by exposing chloroplast (or equivalents thereof) to light in a periodic manner during the organisms' “daylight” cycle.

The present invention further introduces optical, electro-optical, and/or electromechanical techniques to conventional farming methods to increase the conversion efficiency and farming yield many-fold.

### SUMMARY OF THE INVENTION

In one embodiment of the present invention, a module is provided that carries out the above object of the invention including: a solar distribution sub-system; and a structure having a plurality of growing levels configured and dimensioned to support a desired quantity of plant life and associated nutrient sources (e.g., soil, hydroponic, or an equivalent nutrient source).

In another embodiment of the present invention, the above module is provided wherein the solar distribution sub-system comprises a solar energy collection sub-system, an energy storage sub-system, and a light distribution sub-system for periodically distributing light to the plant life at each structural level.

In still further embodiments of the present invention, a water collection sub-system and a distribution sub-system are included in the module. In one example, a water collection sub-system is integrated within the solar energy collection sub system. This may be in the form of channels, e.g., between and/or around certain photovoltaic cells in an array of such cells. In another example, perforations may be included between and/or around cells to collect water (i.e., rainwater).

The above systems may be included with suitable structures and plumbing to direct water to localized collection tanks at each growing level or for each module, or a networked collection tank plumbed to plural modules.

The solar energy collection sub-system and optional water collection sub-system are supported on a structure that, in preferred embodiments, provides structural support to the growing levels. This support structure (e.g., within or alongside one or more pedestals or legs supporting the solar energy collection sub-system) may support or house plumbing to distribute collected rainwater. Further, the pedestals may support or house wiring conduits, such as: from the photovoltaic cell(s) to the energy storage sub-system, from the energy storage sub-system to light systems, control signal wiring from controller system to light system; data signals to collect data from the module.

In still further embodiments of the present invention, a flush or washing cycle may be used on the module. As described above, water from the flush cycle may originate from the holding regions associated with the module, or from reservoirs or tanks. Further, optional solvents may be used in conjunction with flush cycle water. In particular, such cycles are desirable in modules having photovoltaic cells thereon. The flush cycle may be employed to eliminate contaminants from the photovoltaic cells that may block the efficient collection of solar energy. For example, such contaminants may include pollen, debris, droppings, acid rain residue, etc.

### DETAILED DESCRIPTION OF THE INVENTION

Herein disclosed is a system and method for agricultural production (i.e., farming), whereby inefficiencies of conventional farming techniques are overcome according to the above objects of the invention.

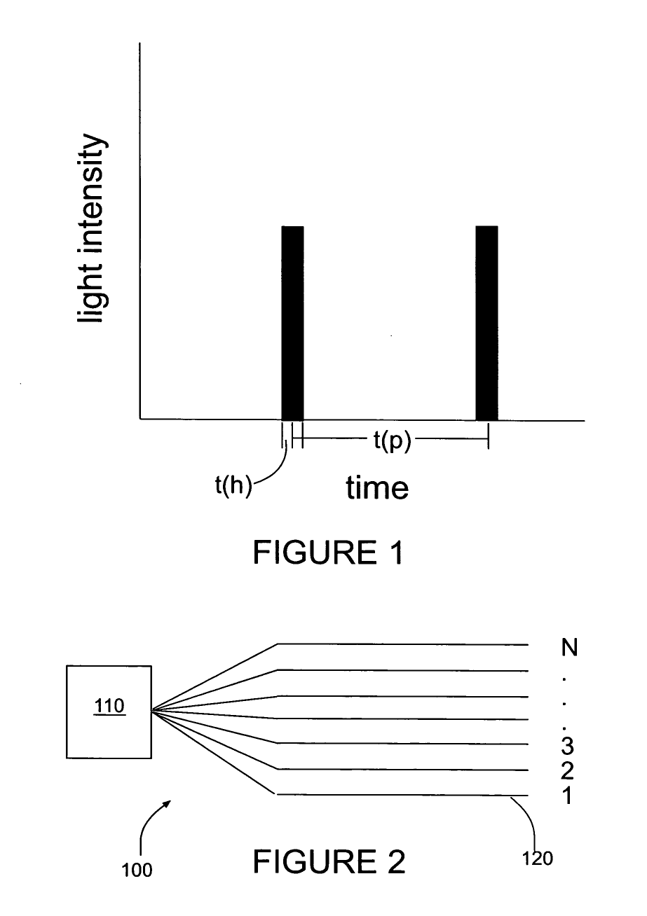

Referring now to FIG. 1, a plot of light intensity as a function of time is shown, as related to one plant or level of plants. As indicated, light intensity is modulated “on” for a time period t(h) at a frequency of 1/t(p). The frequency 1/t(p) represents the harvesting period of the plant life necessary to collect sufficient energy in the form of light photons to carry out a cycle of light and dark reactions, as described in the Background of the Invention. t(h) and t(p) are optimized based on the type of plant life, taking into consideration fundamentals of photosynthesis for that type of plant life, typically based on the light and dark photosynthesis reaction cycles. Furthermore, the values of t(h) and t(p) may vary depending on factors including but not limited to time of day, time of year, desired rate/optimization of growth of the plant life, experimental systems, desired saturation rate of electron transport components other than primary of or other features. In certain embodiments, the time t(h) may be on the order of about 10×10⁻¹⁵ seconds to about 1×10⁻³ seconds. The period t(p) may be on the order of 1×10⁻¹² seconds to about 1 second.

Further, while the various photosystems of photosynthetic life generally absorb photonic energy in parallel, the present invention may be tailored to provide plural light pulses t(h) at various times within a period t(p).

Referring now to FIG. 2, a multiple level faming (MLF) system 100 is shown. In general, MLF system 100 includes an energy distribution sub-system 110 and a plurality (N) of farming levels 120 generally having thereon a desired quantity of plant life and associated nutrient sources (e.g., soil, hydroponic, or an equivalent nutrient source).

The plant life or organism may be selected from the group consisting of vegetables, leafy vegetables, medicinal and other herbs, flowers, fruits, trees, tubers, fungi, cereal grains, oilseeds, and genetically modified plant organisms.

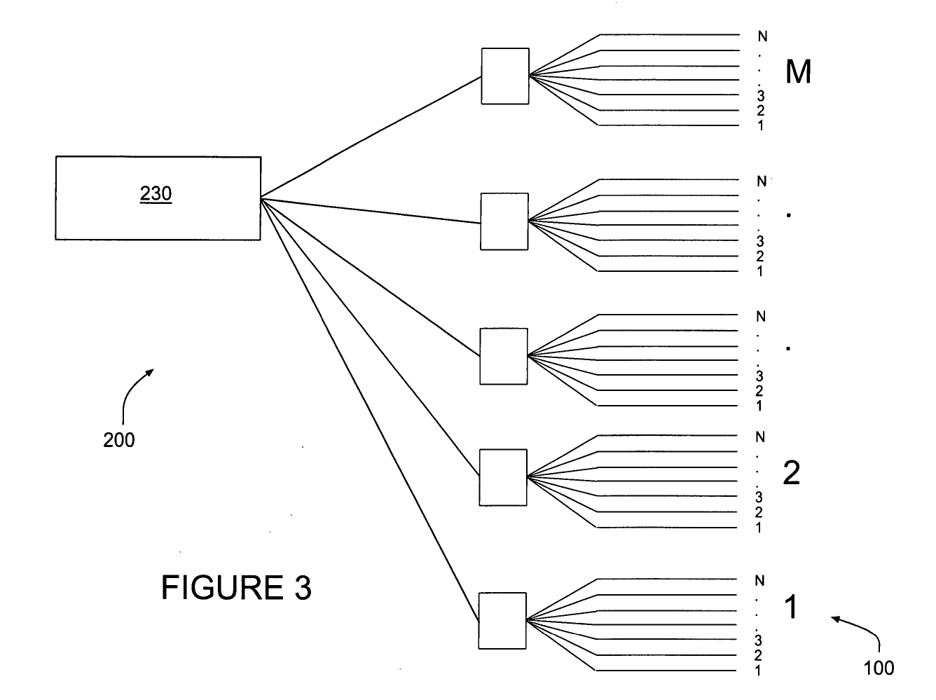

Referring now to FIG. 3, a network 200 of MLF systems 100 is schematically shown. Network 200 may generally include an energy generator 230 coupled to plural energy distribution sub-systems 110 of each MLF system.

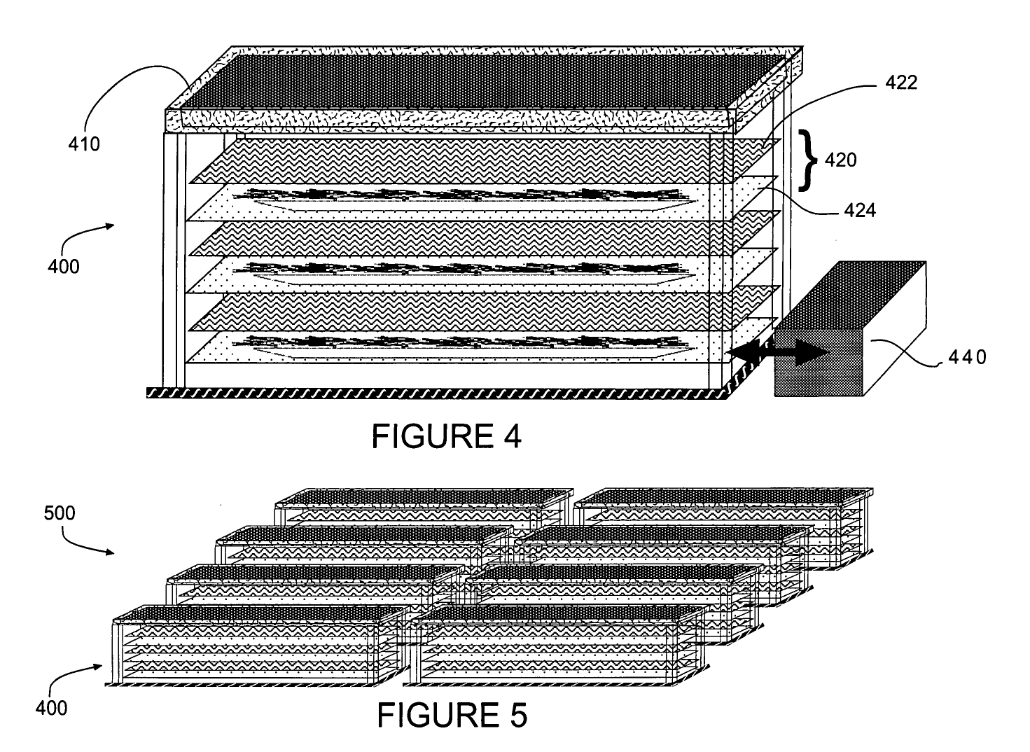

In one embodiment of the present invention, and referring now to FIG. 4, a MLF module 400 is provided that carries out the objects of the present invention. The module 400 generally includes a solar distribution sub-system having a solar collection system 410 for converting solar energy into electrical energy. The converted electrical energy may be stored at an energy storage system 440, or directly distributed to light producing sub-systems 422 at each level 420. Each light producing sub-systems 422 of each level 420 has an associated structural level 424 configured and dimensioned to support a desired quantity of plant life and associated nutrient sources (e.g., soil, hydroponics, or an equivalent nutrient source). The light producing sub-systems 422 may derive energy directly from the solar collection sub-system 410, from the energy storage system 440, or from another source. Light is provided to the plant life under control by a suitable timing controller to carry out the objects described above with respect to FIG. 1. That is, light is cycled on for a period t(h), and off for a period t(d). In more preferred embodiments, to conserve energy, the light sources produce light narrowly constrained about the requisite light bandwidths for the particular plant life.

The N levels of plant life may each be the same or different, in terms of size (generally height will be the only dimension variable between levels), lighting conditions/period/bandwidth, growth medium (soil, hydroponics), temperature conditions, humidity levels, and other conditions.

For example, in certain embodiments, it may be desirable to set certain levels of the system for seedlings, while other levels for more mature plant life.

Alternatively, the present system may be an energy efficient device for growing a variety of plant life in one system, e.g., to support residences, dining establishments, pharmaceutical facilities, hospitals, and the like.

Preferably, such systems having different aspects related to levels N incorporate controller systems dedicated for each level.

Referring now to FIG. 5, a network 500 of MLF modules 400 is schematically shown. Network 500 may generally include a common energy storage system, or plural energy storage systems associated with one or more modules 400. Further, energy distribution may be network controlled, independently controlled, or controlled in suitable groups.

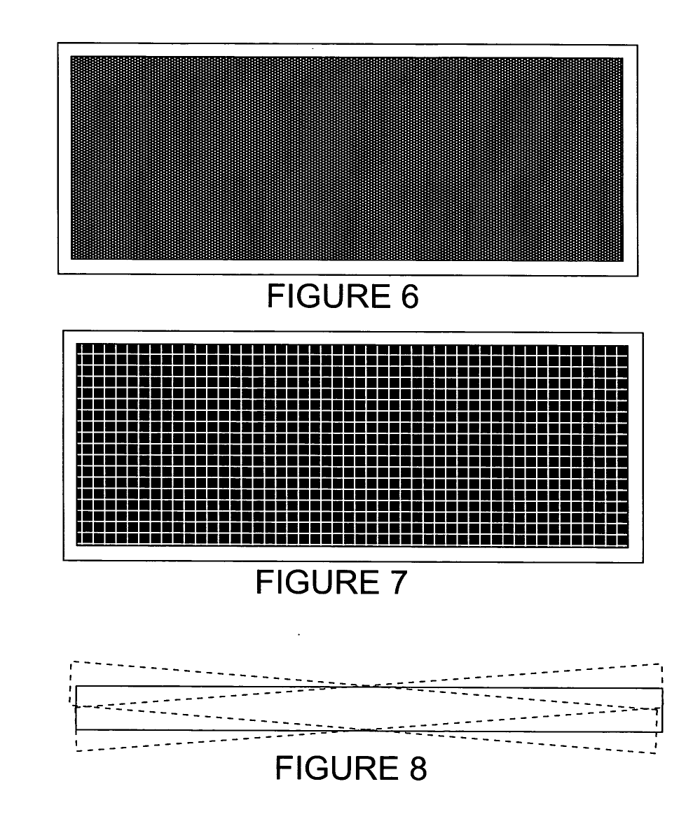

The solar energy collection sub-system 410 may include any suitable solar energy conversion system. The most common type of solar energy collection system are based on photovoltaic cells. Referring to FIG. 6, the solar energy collection sub-system 410 may be provided in the form of a single photovoltaic cell. Referring to FIG. 7, the solar energy collection sub-system 410 may be provided in the form of an array of photovoltaic cells. Referring to FIG. 8, the solar energy collection sub-system 410 also include suitable mechanical structures, for example, to allow sun tracking systems to be integrated therein to optimize solar energy collection/conversion.

The energy storage system 440 may be any suitable secondary battery or battery system, metal fuel regeneration system, hydrogen fuel generation system, or other suitable energy storage system. Generally, the energy storage system 440 includes one or more cells of any suitable secondary battery, including but not limited to lead-acid, nickel cadmium, lithium polymer, nickel metal hydride, or nickel zinc.

Alternatively, all or a portion of energy collected from the solar energy collection sub-system may be fed to a local grid, whereby such grid power may optionally be used for system energy requirements.

The light source may be any suitable electrical light source. Conventional light sources such as halogen, sodium, incandescent, fluorescent, electroluminescent, photoluminescent, or any other suitable light source. Electroluminescent light sources may be inorganic or organic. Alternatively, polymer light emitting electrochemical cells (LECs) may be used, depending on switching speed and control abilities. Preferably, high efficiency light emitting diodes are used, which may, in certain embodiments, be tailored around desired light bandwidths. In certain embodiments, when ultra fast (e.g., on the order of 100 femto seconds) pulses are required, ultra fast laser sources or switches may be used.

A suitable controller may be provided to determine various functional operations of the systems. For example, lighting controls may be programmed in the controller. Irrigation schemes may also be deployed by the controller.

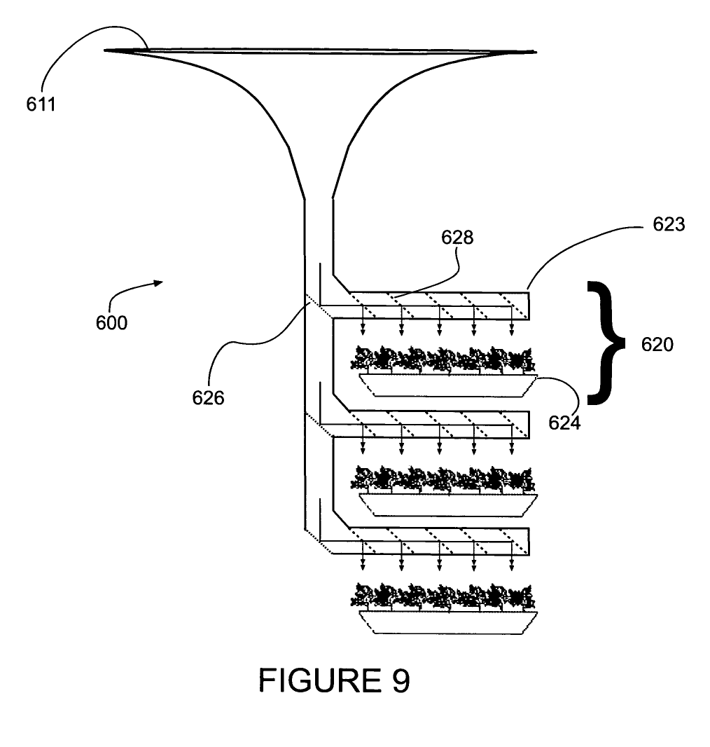

In another embodiment of the present invention, and referring now to FIG. 9, a MLF module 600 is provided that carry's out the objects of the present invention. The module 600 generally includes a solar distribution sub-system including a solar collection system 611 for guiding solar energy through suitable light guides 623 at each level 620. The light is selectively distributed to each level via controllable light valves 626. Light valves 626 may be any suitable electro-optical, magno-optical, electro- or magneto-mechanical light guide structure, liquid crystal structure, or any other controllable device or substance capable of directing light from the collection system 611 to the appropriate level 620 based on the timing system shown in FIG. 1 optimized for the plant life on the structural level 624. A plurality of mirrors 628, or other suitable light reflecting or guiding structures are provided to direct light from the distribution arm 628 to the plant life.

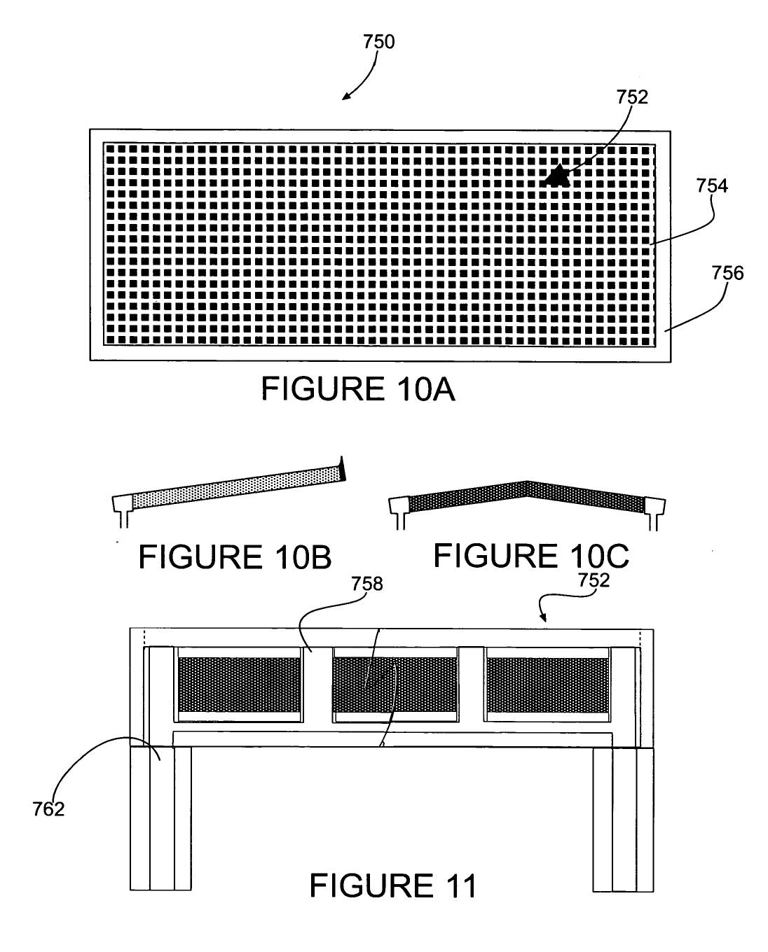

In another embodiment of the present invention, and referring now to FIGS. 10A-10C and 11, an integrated system 750 includes both light conversion and water collection for maximum footprint efficiency.

The integrated system 750 includes a photovoltaic cell array 752 having collection channels 754 generally between photovoltaic cells. A main sub-system collection channel 756 is provided around at least a portion of the periphery of the array.

Referring to FIG. 10B, the array may be configured on a tilted angle allow rainwater flow into periphery channels. Further, referring to FIG. 10C, the array may be gabled to allow flow to multiple periphery channels.

In another example, and referring to FIG. 11, apertures or perforations 758 may be included on a photovoltaic array 752 between and/or around cells to collect rainwater).

Also referring to FIG. 11, in either a channeled system of FIGS. 10A-10C, or an apertured system in FIG. 11, suitable structures and plumbing 762 are provided. Such structures may direct water to localized collection tanks at each level or for each module, or to a networked collection tank plumbed to plural modules.

The solar energy collection sub-system and integrated water collection sub-system are supported on a structure that is configured and dimensioned over the structural levels. This support structure (e.g., within or alongside one or more pedestals or legs supporting the solar energy collection sub-system) may include plumbing to distribute collected rainwater, water and/or nutrient supply to the plant life, or other desired liquid or gas transport.

Further, conduits may be provided for housing electrical wiring, e.g., from the photovoltaic cell(s) to the energy storage sub-system, from the energy storage sub-system to light systems, control signal wiring from controller system to light system, data signals to collect data from the module, or any other desired wires.

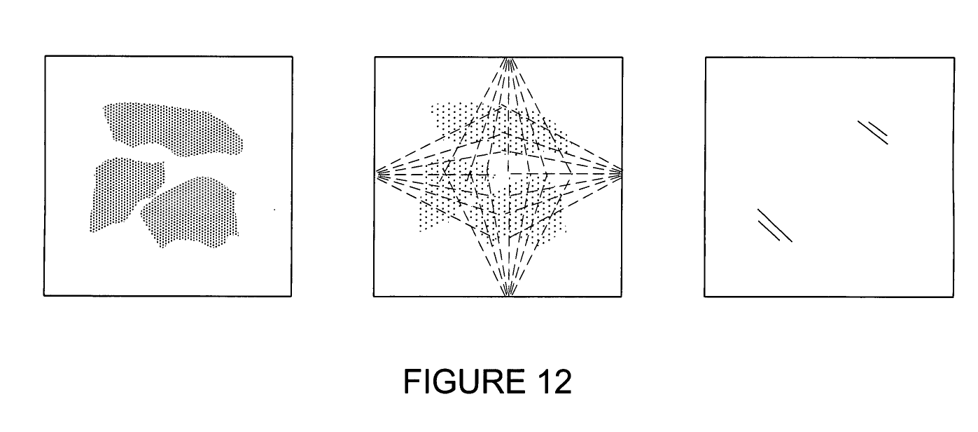

In various embodiments of the present invention, a flush or washing cycle may be used within the module. For example, at various times (e.g., periodically (i.e., every morning, weekly, etc.), based on actual or remote visual inspection, based on efficiency sensors, etc.) water jets may spray the panels to remove accumulated pollen, dust, droppings, acid rain residue, or other contaminates. Water from the flush cycle may originate from the holding regions associated with the module, or from reservoirs or tanks. Further, optional solvents may be used in conjunction with flush cycle water. In particular, such cycles are desirable in modules having photovoltaic cells thereon. Operation of the wash cycle is generally shown in FIG. 12.

In addition to the wash cycle, a wiping cycle may also be incorporated to clean the surface. In certain embodiments, the panel are very large, e.g., meters across. This wiping cycle may use power from the battery or cell. Periodically, e.g., each morning, the system may wash, e.g., as shown above with respect to FIG. 12, and subsequently wipe the panels with suitable wiper structures, examples of which are described herein. Thus, by maintaining the cleanliness of the panels, solar energy collection efficiency is increased. In systems that are not cleaned, over periods of no rainfall, dust, pollen, etc. all build up and decrease efficiency.

Additionally, the solar panels may be kept clean (thus maintaining optimum efficiency) by other inherent means. For example, PV panels used in the present systems may integrate self cleaning feature, including but not limited to inclusion of hydrophobic materials/coatings, sonic wave systems, and electrical charge systems.

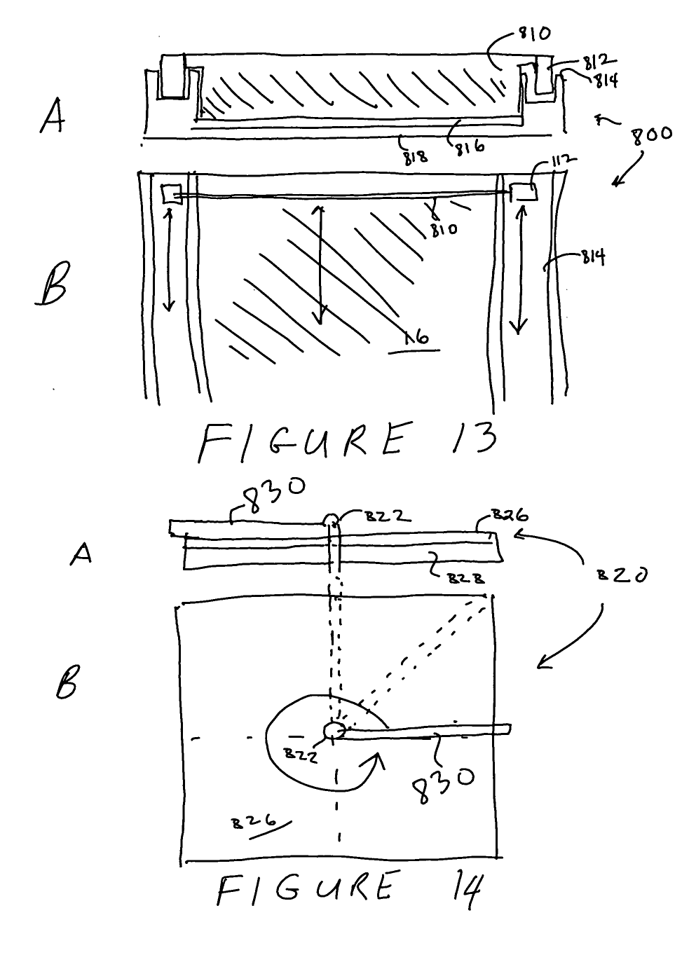

For example, one wiper structure for a farming module 800 (having any or all of the features heretofore described) is shown with respect to FIGS. 13A and 13B. FIG. 13A shows a sectional view, and FIG. 13B shows a top plan view of the system 800. The module 800 generally includes a supporting based 818 and a solar panel 816 on the base 818, presuming that multiple levels are suitably configured and positioned therebeneath. A wiper structure 810 is provided, having, e.g., gliders or wheels 812 configured, dimensioned and positioned to traverse channels 814 of the module 800. Suitable motors, actuators, or the like, which may be under the control of a suitable controller or network, as described herein, are employed to allow the wiper 810 to traverse and wipe the solar panel 816 when needed, or periodically.

Referring now to FIGS. 14A and 14B, an embodiment of a radial wiper structure is shown incorporated in a farming module 820. Module 820 includes a solar panel 826 generally supported on a based 828 of the module 820. The wiper 830 is rotated by action of a motor 822, suitable controlled as described herein.

In addition to the active wipers, the solar panel, or a transparent cover to the solar panel, may incorporated self cleaning features, including but not limited to hydrophobicity, sonic wave systems, suitable electrical charge systems, or other suitable systems.

The power storage and distribution system may also vary in the present systems of the invention. For example, the energy storage (i.e., battery) may be based on modular batteries (e.g., one for each module), or batteries coupled to several modules of the present invention. Further, the power distribution sub-systems (e.g., to control lights, pumps, and other energy consuming sub-systems) may include DC-AC inverters, or the lights may be based on DC voltage. Alternatively, power may be collected in phase, allowing AC power transmission with suitable step-up transformer, as is well known in the art.

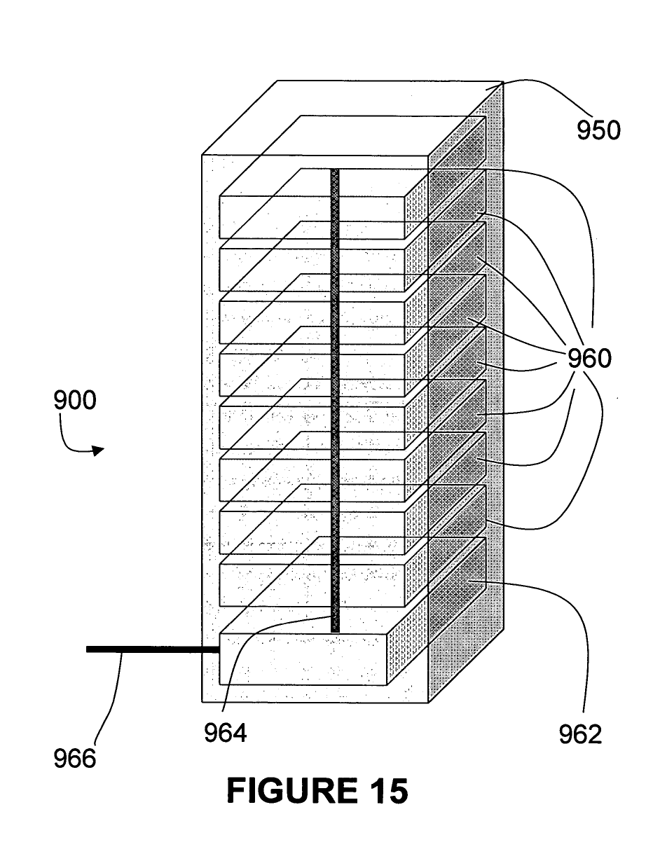

Referring now to FIG. 15, another embodiment of the present invention is shown. A MLF system 900 includes plural levels 960 within an enclosure 950. A support module 962 is provided to provide support to the plural levels 960. The support may be in the form of energy (e.g., for energizing photonic sources associated with each level), carbon dioxide, water, nutrients, or other needs of the plant life. Further, controllers and sensors may be incorporated within the support module 962. A bus 964 interconnects the levels 960 of the MLF 900. In certain embodiments, the MLF system 900 may be partially self-sustaining. However, outside sources of power, water, carbon dioxide, nutrients, etc. may be introduced schematically illustrated with line 966.

A further benefit of the MLF system 900 is that since it is enclosed and has its own environment, detriments associated with genetically engineered plant life are minimized or eliminated. On the one hand, using the MLF system 900, fear of spreading of the genetically engineered plant life is minimized. On the other hand, using the MLF system 900, genetically engineered plant life may be grown therein without fear of spreading to other agricultural sources (e.g., conventional farms) or overcoming indigenous plant life.

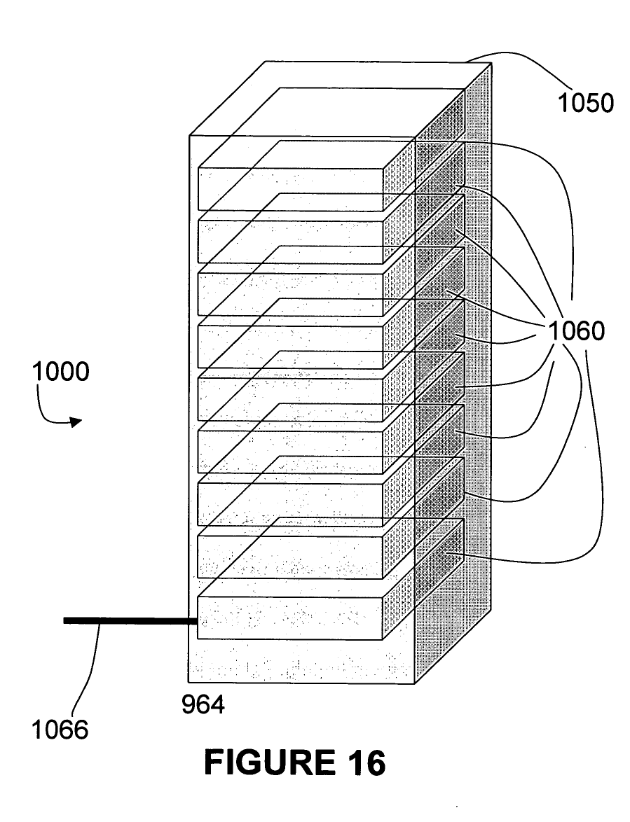

Referring now to FIG. 16, another embodiment of the present invention is shown. A MLF system 1000 includes plural levels 1060 within an enclosure 1050. In contrast to the system of FIG. 16, each level 960 may include therein requisite support systems, such as energy (e.g., for energizing photonic sources associated with each level), carbon dioxide, water, nutrients, or other needs of the plant life. Further, controllers and sensors may be incorporated within each level 1060.

Thus, the benefits of the present invention are particularly significant related to optimizing land use efficiency and energy, while providing a controlled environment for growing plant life.

In certain embodiments, the systems may be isolated from surroundings, such that, for example, during agriculture of genetically engineered plant life, there is no threat of undesirable spreading of such genetically engineered plant life.

Further, the space used by the system is maximized, as plants are grown underneath, and water is collected above. In certain embodiments, both water and energy is collected above. This has clear advantages over conventional farming techniques using separate reservoir or pond water storage.

Another key benefit of the present invention is that the module may be partially or completely self-sustaining. Power for the control systems, pumps, motors (e.g., of sun-tracking systems, displacement systems, wiper systems) may be supplied from any integral PC cells, from batteries having energy captured from the PV cells, or from a conventional power grid. However, in preferred embodiments, a substantial amount of the module power is derived from the PV cells and/or batteries.

While preferred embodiments have been shown and described, various modifications and substitutions may be made thereto without departing from the spirit and scope of the invention. Accordingly, it is to be understood that the present invention has been described by way of illustrations and not limitation.

1. A method of growing plant life comprising modulating light intensity “on” for a time period t(h) at a frequency of 1/t(p), representing the harvesting period of the plant life necessary to collect sufficient energy in the form of light photons to carry out a cycle of light and dark reactions, and modulating light intensity “off” for the time required between harvesting periods.

2. A module for glowing plant life according to the method of claim 1.

3. The module claim 2, comprising:
a. a solar distribution sub-system; and
b. a structure having a plurality of growing levels configured and dimensioned to support a desired quantity of plant life and associated nutrient sources (e.g., soil, hydroponic, or an equivalent nutrient source).

4. The module as in claim 3, wherein the solar distribution sub-system comprises a solar energy collection sub-system, an energy storage sub-system, and a light distribution sub-system for periodically distributing light to the plant life at each structural level.

5. The module as in claim 2, further comprising a water collection sub-system and a distribution sub-system.

6. The module as in claim 4, further comprising a water collection sub-system and a distribution sub-system, wherein the water collection sub-system is integrated within the solar energy collection sub system.

7. The module as in claim 6, wherein channels are provided between and/or around certain photovoltaic cells in an array of such cells.

8. The module as in claim 6, wherein perforations are included between and/or around cells to collect water.
